(19) United States
(12) Patent Application Publication
(10) Pub. No.: US 2007/0283575 A1
(43) Pub. Date: Dec. 13, 2007

(54) Pull-type, hand-held package opener with pivoting blade guard

(76) Inventors: Martha R.C. HIX, Kerrville, TX (US); Carl Walter Hix, Kerrville, TX (US); Carl James Watson, Mason, TX (US)

Correspondence Address: RUBICON TOOLS LLC, PO BOX 293785, KERRVILLE, TX, 78029, US

(21) Appl. No.: 11/423,441

(22) Filed: Jun. 10, 2006

(51) Int. Cl. B26B 29/00

(52) U.S. Cl. 30/294; 30/2

(57) ABSTRACT

The device is a hand-held, ergonomic-friendly pull-cut tool for opening transparent thermoformed (heat-sealed plastic) over-packaging that encapsulates small consumer products. Consumers find it difficult to remove these thermoformed “clamshells.” Our package opener with pivoting blade guard safely and effectively removes these thermoformed enclosures by piercing and slicing the plastic in one smooth motion.

### BACKGROUND OF THE INVENTION

The presented invention relates to a cutting tool, U.S. Cl. 30.

Background of the endeavor.

For theft-prevention as well as for friendly retail display, mass-market merchandisers often require high-volume small consumer products to be encapsulated in tamper-proof, thermoformed (heat-fastened plastic) packaging. These transparent over-wraps are commonly referred to as “clamshells.”

Consumers young, old, and in between find it difficult to remove the mentioned clamshells—they defy hands, scissors, knives, and/or teeth, and deplete patience.

While the presented invention cuts and slices through assorted media, such as blister packs, cartons, straps, and potato-chip sacks, the device has various other uses limited only by the imagination of the user; however,

this cutting tool is particular to removing rigid thermoformed over-wraps: clamshells.

The abject difficulty of taking a consumer item out of one of those difficult over-wraps prompted the invention of our cutting tool.

Our invention differs from previous package openers, such as U.S. Pat. No. 4,167,810, U.S. Pat. No. 7,003,884, and U.S. Patent Application 20050102838.

The first mentioned, U.S. Pat. No. 4,167,810, is a pull-type package opener, and it is somewhat comparable to our device, but theirs is particular to cardboard cartons and to flat-sheet cutting, utilizing a rounded nose and/or a hooked blade, neither of which feasibly pierce plastic over-wraps with ease, nor does their package opener appear to be designed to slice through odd shapes, as ours does.

U.S. Pat. No. 7,003,884, the second example, is an invention with the same intention as ours, to open thermoformed over-wraps, but our package opener differs from U.S. Pat. No. 7,003,884, because that opener is a push-type apparatus that might be difficult to use, especially for heavier-weight thermoformed packaging, and the ratcheting action often required for pushing the gadget could cause repetitive-motion problems for users with physical disabilities such as arthritis. Our presented invention utilizes the ease of pull rather than push.

U.S. Patent Application 20050102838 describes yet another clamshell package opener. This one features two jaws that grasp the clamshell between the mentioned jaws, which indicates that this gadget is best used as an edge cutter, while our invention cuts any and all aspects of a clamshell.

Our device is made to pull rather than to push, and the combination of handle shape, blade position, and pulling action results in an excellent and unique cutting tool heretofore not seen: a tool that opens clamshells of all weights, easily, effectively, and efficiently.

Several subclasses under U.S. Cl. 30, describe our device.

Subclass 143 relates to cutting tools that are sheathed when not in use.

Subclass 286 relates to the guard aspect of cutting tools, and our invention's blade guard protects hands and fingers from injury.

Cutting tools that are operated by a direct pull on the handle are described in Subclass 314, and this subclass most accurately describes our package opener.

### BRIEF SUMMARY OF THE INVENTION

The invention is a pull-type, hand-held cutting tool with pivoting blade guard, comprised of four parts, plus any fasteners for assembly, none described hereto:

a two-piece handle that is spherical on the side, while being rectangular and slim on the front and top sides, and when the two pieces of the handle are assembled the pieces becomes the one-piece handle housing;

a blade guard that provides the safety features; and,

a commercially obtained blade that is straight and sharp on its cutting edge and is slanted in presentation.

Our package-opener invention pierces any part of thermoformed packaging, no matter the clamshell's shape, e.g., round, square, convex, and/or concave.

The abovementioned tool slices in a pulling motion via a single, immobile blade that when not in operation is shielded with a pivoting guard.

The broad purpose of the invention is to provide a reliable, easy to use, compact, safe, and ergonomic means to remove consumer goods from clamshell outer-wrappings.

### BRIEF DESCRIPTION OF THE SEVERAL VIEWS OF THE DRAWING

FIG. 1 is an assembled view of our hand-held cutting tool with pivoting blade guard, in the closed position.

FIG. 2 is an assembled view of our hand-held cutting tool with pivoting blade guard, in the open position.

FIG. 3 demonstrates the two-part, spherical handle housing, assembled.

FIG. 4 shows three views of our device:

the first half of the spherical handle (1);

the cutting blade that is straight and sharp on its cutting edge and is slanted in presentation (3); and,

two views of the blade guard (4), side and interior.

FIG. 5 gives an inside view of the second half of the spherical handle housing (2); and,

FIG. 5 also includes a rear view (2k) of the assembled tool with the blade guard (4) in the closed position, demonstrating that the device is rectangular and slim in the front, back, top, and bottom aspects.

### DETAILED DESCRIPTION OF THE INVENTION

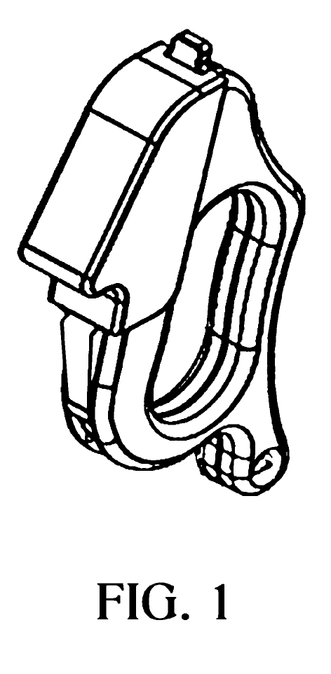

The presented invention is an exemplary hand-held, pull-type cutting tool with pivoting blade guard (FIG. 1), designed purposely to pierce and incise thermoformed outer-packaging of consumer goods.

For theft-prevention as well as for friendly retail display, mass-market merchandisers often require high-volume small consumer products to be encapsulated in tamper-proof, transparent thermoformed over-wraps. These containers are commonly referred to as “clamshells.”

Consumers of all ages and levels of fitness, even athletes, find it difficult to remove the mentioned clamshells-they defy hands, scissors, knives, and/or teeth, and deplete patience.

Our apparatus is particular to slicing those rigid, aggravating clamshells with ease and efficiency, but the tool also performs a myriad of additional duties, not limited to opening blister packs, cartons, shipping straps, and snack sacks.

This cutting tool with pivoting blade guard (FIG. 1) is usually formed from sturdy polymer material or materials such as ABS or nylon glass-fill, except for the metal blade and any or all of the device's fasteners, none of the latter being shown, as the device can be assembled either by screw or by ultrasonic welding.

Our device slices in a pulling direction. Pulling is a more straightforward method for opening clamshells, rather than pushing. Push-type clamshell openers might become stalled, necessitating the user to operate the push-opener in a ratcheting manner, which is . . .

inefficient; and/or,

detrimental to users who suffer physical ailments that are aggravated by repetitive motions.

Our four-part invention becomes three sections upon assembly, but unassembled, it includes:

Firstly, the handle housing.

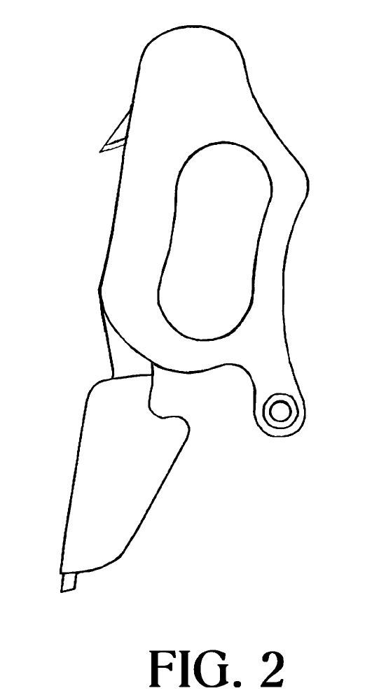

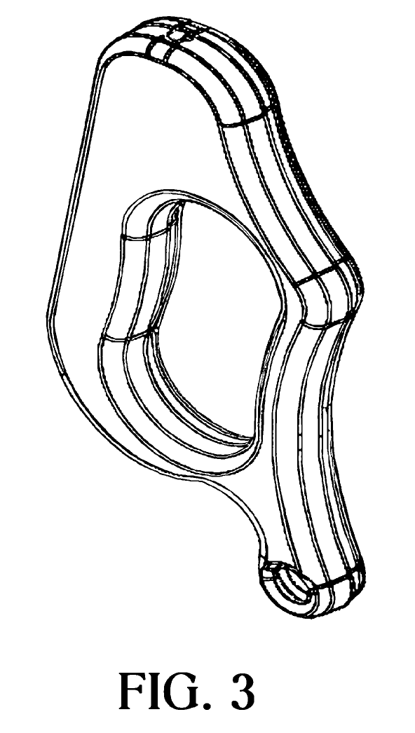

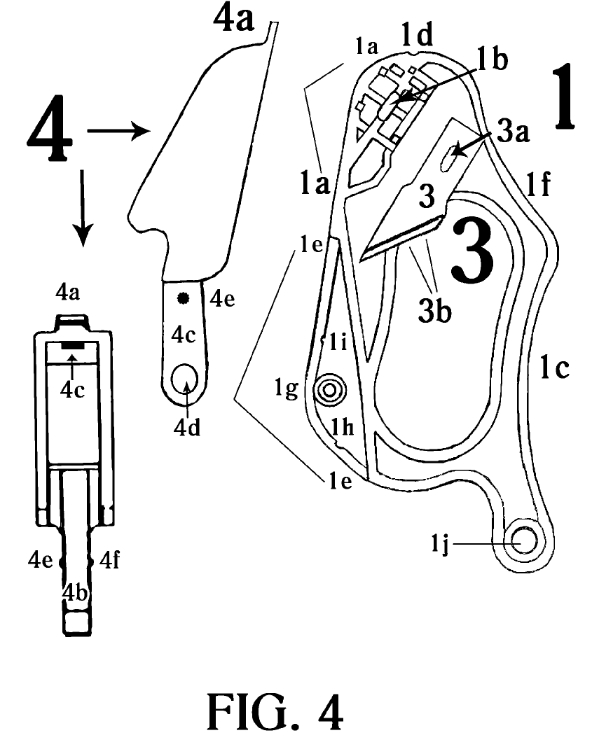

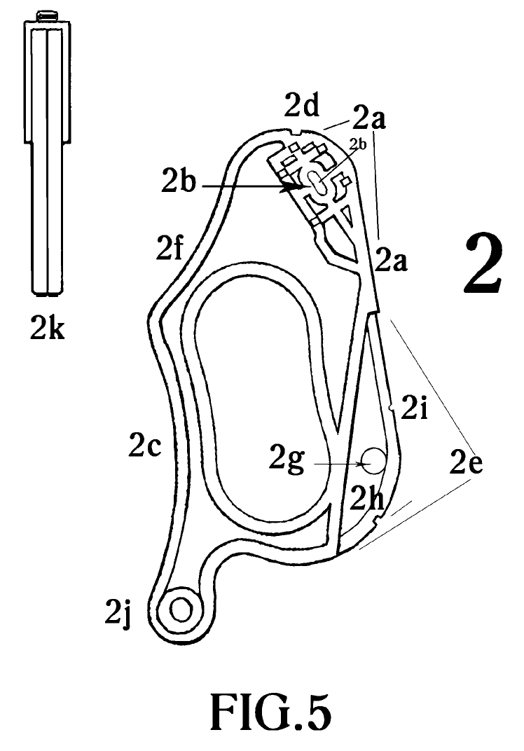

There are two handle halves (1, FIG. 4 and 2, FIG. 5), the components of each matching at assembly to create the handle housing (FIG. 3).

The handle housing features a tail at the bottom and this tail contains a convenience feature, a keyhole (FIG. 4, 1j, FIG. 5, 2j).

When assembled, the handle housing (FIG. 3) is spherical in shape on its sides and rectangular on its front, back, bottom, and top (FIG. 5, 2k); and, the handle housing's design aspect is centered toward ergonomic comfort.

The lower, posterior portion of the assembled handle housing functions as a concave-to-palm, convex-to-fingers grip (the parts seen in 1c, FIG. 4 and 2c FIG. 5). Easy to grasp, this finger grip is thin, and the user's hand just as easily conforms to its shape.

The upper posterior section of the handle housing (FIG. 3) constitutes the thumb rest (1f, FIG. 4 and 2f, FIG. 5). Having the consumer's thumb on that thumb rest helps steady the device as it severs the clamshell, and the concave shape places the user's thumb in an excellent position in relation to the blade's slant. The design as a whole provides optimum dynamics for the pulling action, while it keeps the user's fingers well away from the cutting blade.

Also depicted on FIGS. 4 and 5 are notches labeled “1d” and “2d,” respectively. These matched notches at the apex of handle housing receive the fastening strip (4c, FIG. 4). These notches are utilized for locking the device to a closed position, and are mentioned in [00062].

The second part of our exemplary cutting tool is an angled metal blade (3, FIG. 4), with no design claim being made by this patent application for the said blade.

This metal blade features a hollow loading slot (3a) for stabilization; and,

the blade (3) is sharply honed at its scoring point and on the base of its leading edge (3b), with the cutting surface straight in design.

The cutting plane presents at sixty degrees (60°) from the handle housing; this angle is critical to our device.

The final element of our invention is a molded blade guard (4, FIG. 4) that rotates from the pivot channel (FIG. 4, 1e; FIG. 5, 2e) on an attached arm (4b), and the rotating radius equals one-hundred eighty degrees (180°).

An important aspect of the invention is safety, and this blade guard serves two safety purposes.

When the device is closed, the consumer cannot touch the sharp blade.

When the device is open, the blade guard locks to the anterior lower portion of the handle housing, forming a barrier between the item to be sliced and the user's hand, and by doing so, the consumer's fingers touch neither the cutting blade nor the clamshell, the latter having sharp edges after being sliced.

The blade guard (4, FIG. 4) contains several aspects . . .

a release tab (4a, FIG. 4) to open and to close the blade guard; this tab is located at the blade guard's apex;

a pivot arm (4b, FIG. 4) with hinging hole (4d);

a fastening strip (4c, FIG. 4) on the blade guard's interior, and this strip is directly below the mentioned release tab (4a); this strip fits to grooves (1d, FIG. 4; 2d, FIG. 5) at the apex of the handle housing, to close the blade guard;

the fastening nubs (4e, 4f, FIG. 4) that are located on the exterior of the blade guard's arm (4b); the nub on the first side of the view (4e) fits to a notch (1h) in the FIG. 4 view of the handle when the cutting tool is in the open position, and this nub (4e) fits to another notch (1i) in the closed position.

In the second side of the view (FIG. 5), there is an action that mirrors the paragraph above this one. The nub (4f, FIG. 4) fits to a notch (2h, FIG. 5) when the cutting tool is in the open position, and the said nub (4f, FIG. 4) snaps to a notch (2i, FIG. 5) to secure the blade guard in its closed position, and,

thusly, the set of notches and nubs are utilized to lock the device in its open and closed positions.

Blade Stabilization.

The cutting blade (3, FIG. 4) with post-loading slot (3a) is stabilized by a rail-and-post group (1a, 1b, FIG. 4; 2a, 2b, FIG. 5). Starting with the first half of the handle (1, FIG. 4), the receiving rail (1a) and its oblong post (1b) are located inside the handle's upper anterior segment.

Assembly.

To assemble the cutting tool, the blade's post-loading slot (3a, FIG. 4) fits over the oblong post (1b); the blade then rests on the receiving rail (1a); and, afterwards . . .

the second half of the handle housing (2, FIG. 5) mounts to the first half (1, FIG. 4) to become the handle housing (FIG. 3), and in doing so, the tabs on the rail (1a, FIG. 4) snap to the pitted rail (2a, FIG. 5) and the post (1b, FIG. 4), which now carries the blade (3), slips into the receiving slot (2b, FIG. 5), thus stabilizing said blade.

On the blade guard's arm (4b, FIG. 4) is found a circular hinge opening (4d); this hole fits over the pivot's receiving post (1g) when the two-part handle (1, 2) is assembled into the handle housing (FIG. 3); and,

a fastener, either a screw or other means not shown, is then riveted to the blade guard's pivot mechanism, by penetrating the designated hole (2g, FIG. 5) in the handle, and then by penetrating the handle hole (4d, FIG. 4) of the guard's arm (4b), and then by fastening the aforementioned fastener to the receiving post (1g).

Thus assembled, the guard's arm secures to the handle housing.

The final step in assembly is to attach the screws, or to proceed with the ultrasonic welding, and after either means of assembly, the package opener is complete.

Operating the Package Opener.

To open and close the cutting tool, the blade guard rotates from it recessed channel (1e, FIG. 4; 2e, FIG. 5) in the tool's lower anterior section.

A consumer opens the device by clasping the finger grip with one hand and pushing the blade guard's release tab (4a, FIG. 4) away from the device with the other hand.

The user then guides the blade guard (4, FIG. 4) downward to snap the pair of fastening nubs (4e, 4f) into grooves located in the blade guard's pivot channel, (1h, 1i, FIG. 4; 2h, 2i, FIG. 5).

To use the cutting tool, a consumer firmly grips the cutting tool in one hand; and, with the free hand, firmly steadies the thermoformed clamshell above and away from the blade insertion point; and,

pierces the clamshell at any point; and,

leaves the blade (3, FIG. 4) inserted in the said over-wrap.

With the blade still inserted in the over-wrap, the consumer pulls the invention around the circumference of the clamshell.

The sixty-degree (60°) angle of the slanted, sharp-edged blade keeps said blade from popping out of the clamshell as the tool smoothly slides around the over-wrap, until the original product can be removed.

The abovementioned cutting technique is successful, no matter the shape of that clamshell, be it round, square, convex, or concave.

To close the cutting tool, a consumer holds the cutting tool in one hand and with the other, lifts the blade guard, preferably by the release tab, and applies enough pressure to slip the guard's fastening nub (4c, FIG. 4) into the top notch of the handle housing (1d, 2d).

By comparison, cutting tool U.S. Pat. No. 4,167,810, dated Sep. 18, 1979, is designed to open sheet material, specifically cardboard shipping boxes, utilizing a two-step approach. A carton of, for instance, canned goods is punctured with the rounded nose of the tool, and if the carton is too tough to be opened by the rounded nose, then, the tool's recessed point, which is a sharp and curved hook that is tucked above the rounded nose, closer to the common handle, is used to puncture the carton.

Next, the piercing blade of U.S. Pat. No. 4,167,810 must then be removed from the carton, and the rounded nose is inserted in the punctured shipping box. Starting at the said puncture, the rounded nose then makes a pull-cut between the shipping box and the goods that were shipped in said box, such as those canned goods. Conversely, our invention pierces and slices in one motion.

U.S. Pat. No. 4,167,810, the curved-hook cutting tool mentioned in the previous paragraph, is designed to cut only sheet material or a square-edged object, such as a shipping box. A curved hook will not easily, if at all, pierce thermoformed over-wraps. The blade (3, FIG. 4) in our invention is sharp and pointed, with a straight, slanted cutting edge (3b), and our cutting tool is capable of easily piercing plastic and/or other materials.

U.S. Pat. No. 7,003,884, issued Feb. 28, 2006, also pertains to a cutting tool, and that particular invention is primarily used for clamshell packaging removal. While this tool utilizes a second blade to pierce over-wraps, this tool is designed to push-cut only.

The disadvantages of push tools, like U.S. Pat. No. 7,003,884 above, for clamshell removal are previously detailed, spelling out that pushing to cut clamshell packaging is . . .

inefficient; and/or,

can be harmful to users who suffer physical ailments that are aggravated by repetitive ratcheting.

U.S. Patent Application 20050102838 describes yet another clamshell package opener, and this one features two jaws that grasp clamshell edges, via a “combined action of a clamp and a cutting edge that permit a simple sliding movement to produce a linear cut . . . ” This cutting tool isn't designed to pierce any part of a clamshell that can't fit between the tool's jaws and its design doesn't seem to indicate an ability to cut diverse thermoformed shapes.

Our presented cutting tool is ideal and it improves upon the former art of openers for thermoformed over-packaging by . . .

piercing and slicing in one cut;

operating with a pull-cut rather than a push-cut;

cutting all shapes of clamshells, not just the edges;

fitting the user's hand easily, which not only is ergonomically advantageous, it also beneficial to the force that goes into the cutting motion; and,

supplying a sturdy blade guard for safety.

In summary, our invention pierces and slices thermoformed material, and does it easily, cleanly, and efficiently; the device is safe, given that it has a blade guard; it is sturdy, made of high-grade polymers; it is compact, where it can be fastened to a keychain, or slipped into a handbag or shirt pocket; and, the cutting tool is designed to fit comfortably in the hand.

Lastly but most importantly, our package opener fills a long-needed consumer need for a reliable, safe, efficient package opener to remove those clamshell and other packaging materials.

What is claimed is:

1. A cutting tool that is manipulated with one hand, consisting of:
a two-part handle housing;
a single blade; and,
a molded blade guard that rotates from a pivot post.

2. The cutting tool set forth in claim 1, whereas the handle housing, at its upper rear quadrant and lower rear quadrant, serves as the thumb rest and the finger grip, respectively; and, at the bottom of the handle housing is a tail that contains a convenience feature, a keyhole.

3. A cutting tool, set forth in claim 1, that . . .
is spherical in the side views of its handle housing, but with deviations in form for ergonomic and cutting-force considerations of the finger grip and the thumb rest; and,
the handle housing is rectangular and slim in its front, rear, top, and base views.

4. A cutting tool, described in claim 1, that holds a blade that is slanted and contains a sharp, straight cutting edge, of which no claim is made to the blade's design; and,
said blade is stabilized by a rail-and-post support system contained in the interior of the handle housing, at the upper and anterior quadrants; and,
said cutting blade presents from the handle housing at sixty degrees (60°); this angle is crucial to the successful operation of the mentioned cutting tool.

5. A cutting tool, set forth in claim 1, containing a molded, pivoting blade guard, and this blade guard . . .
attaches to a riveted post in the lower quadrant of the handle housing; and,
rotates in a one-hundred eighty degree (180°) track to open and to close the cutting tool.

6. A cutting tool, set forth in claim 1, the purpose of which is to incise and slice thermoformed (heat-fastened plastic) transparent over-packaging, aka “clamshells”.

7. A method for operating the cutting tool set forth in claim 1, by way of opening the said cutting tool:
the handle housing is grasped by the finger grip;
the thumb rests on a concave area above the finger grip;
the blade guard's release tab, located at the apex of the handle housing, is pushed in a direction away from the cutting tool, and then it is guided downward to snap onto fastening nubs located in the blade guard's pivoting channel.

8. A method for operating the cutting tool set forth in claim 1, by way of closing the said tool, to wit:
the blade guard is brought upward, then halfway over the handle housing, until the tab on the underside of the blade guard snaps into the nub located at the apex of the handle housing, and thus the blade guard settles into the closed position.

9. A method to use the cutting tool set forth in claim 1:
a consumer firmly grips the cutting tool in one hand, steadying the over-wrap in the other, and then the blade of the cutting tool punctures any part of the thermoformed material; and,
leaving the blade inserted, with the clamshell held above and safely away from the sharp blade, the cutting tool is then pulled around the circumference of the clamshell, until the original consumer item can be removed from said clamshell; and,
the sixty-degree (60°) angle of the blade has kept the blade from popping out of the clamshell during operation, and this cutting technique is successful, no matter the shape of that clamshell, be it round, square, convex, or concave.
